(19) United States
(12) Patent Application Publication
(10) Pub. No.: US 2009/0067785 A1
(43) Pub. Date: Mar. 12, 2009

(54) Optical device comprising an apodized bragg grating and method to apodize a bragg grating

(76) Inventors: Silvia Ghidini, Milano (IT); Maurizio Tormen, Belluno (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/886,954

(22) PCT Filed: Mar. 25, 2005
(86) PCT No.: PCT/EP2005/003202

§ 371 Date: Sep. 24, 2007

(51) Int. Cl. G02B 6/34

(52) U.S. Cl. 385/37

(57) ABSTRACT

An optical device, i.e., a wavelength selective filter, includes a grating having a finite length and is capable of filtering a given first wavelength within an operating wavelength region, said grating including a plurality of consecutive sections, each section including two sub-sections: a first sub-section having a first period Λ and a second sub-section having a second period Λ₁, wherein said first period (Λ) satisfies the Bragg condition for said given first wavelength and the second period (Λ₁) satisfies the Bragg condition for a second wavelength lying outside the operating wavelength region so as to form a grating with modulated coupling coefficient, wherein the succession of lengths of each section is non periodic. Preferably, the first (Λ) and second period (Λ₁) are such that nΛ=mΛ₁, wherein n and m are integers and satisfy one of the following conditions: if Λ₁>Λ, n/m is not an integer and if Λ₁<Λ, m/n is not an integer. The reflection spectrum of the apodized grating does not exhibit Moiré replica over a relatively large operating wavelength region, e.g., the C-band.

### TECHNICAL FIELD

The present invention is relative to an optical device including an apodized Bragg grating and to a method to apodize a Bragg grating. In particular, the apodization of the present invention is such that sidelobe suppression in the optical device spectral response is achieved, also in case of physical gratings fabricated by etching.

### TECHNOLOGICAL BACKGROUND

Bragg gratings (BGs) are well recognized as key components in Wavelength Division Multiplexing (WDM) systems, due to their flexibility and unique filtering performances. For passive devices in WDM communication systems, sharp, well-defined filter amplitude responses are crucial.

Such gratings are realized in a waveguide (in the following with the term “waveguide” also fibers are included) by a periodic or substantially periodic modulation of the refractive index of the waveguide. The term pitch is used to designate the modulation period along the waveguide.

The grating reflects selectively wavelengths λ_{B} (called Bragg wavelength) that satisfy the Bragg condition: λ_{B}=2·n_{eff}·Λ, where n_{eff} is the effective refractive index of the waveguide where the grating is realized and Λ is the grating period.

The reflection spectra of filters including uniformly distributed (or uniform) gratings exhibit large secondary (or side) lobes. These sidelobes typically cause crosstalk between wavelengths, e.g. between the adjacent channels in a WDM communication system.

Various methods have been proposed for producing optical filters exhibiting a spectral response with secondary lobes suppressed or reduced in intensity. Such methods are called apodization methods, in which a convenient tailoring of the coupling coefficient (or grating strength) along the grating is introduced. Typically, the reflection spectrum of a grating filter is apodized by gradually increasing and then decreasing the grating strength along the waveguide.

Several approaches for apodizing a grating structure have been reported in the literature, in particular for gratings obtained through an UV exposure of the photorefractive waveguide. Among these apodization methods, the use of a phase mask with a variable diffraction efficiency, phase mask dithering or double exposure method are commonly known.

On the other hand, if physical corrugation of the waveguide is used in order to obtain the effective refractive index modulation, fewer and less flexible approaches are possible.

A first possibility is to vary the corrugation and hence the etch depth. J. T. Hasting et al. in “Optical waveguides with apodized sidewall gratings via spatial-phase-locked electron-beam lithography”, published in Journal of Vacuum Science Technology, vol. B 20, pp. 2753-2757 (2002), describe a silicon-on-insulator rib waveguides having sidewall gratings. Calculated spectra for a rib waveguide having a grating with raised cosine apodization are shown. In the described geometry of the waveguide grating, the rib narrows slightly as the grating depth increases in order to maintain a constant mode's effective refractive index.

Applicants have noted that, in order to keep the etching process simple and reproducible, a binary etching, i.e., wherein the etch depth is constant along the grating, is strongly preferable.

In US patent application no. 2004/0190829 in the name of Ansheng Liu et al., a waveguide Bragg grating is disclosed, where the Bragg grating is apodized by varying the duty cycle of selected grating periods while fixing the pitch of the grating periods. Another apodization method with varying duty cycle is described in “Apodized Surface-Corrugated Grating with varying Duty Cycles” written by D. Wiesmann et al. and published in IEEE Photonics Technology Letters, Vol. 12, n° 6, June 2000, pages 639-641. The Bragg grating is realized by concatenating different duty cycles. The gratings were fabricated in SiON planar waveguide.

Applicants have noted that a duty cycle variation causes a variation of the local mean value of the effective refractive index. Said variation results in a non-symmetric spectral response of the filter. In other words, if a symmetric spectral response with high sidelobe suppression is desired, the effective refractive index local mean value needs to be kept constant.

In “Coupling Coefficient Modulation of Waveguide grating Using Sampled Grating” written by Yasuo Shibata et al. and published by IEEE Photonics Technology Letters, Vol. 6, n° 10, October 1994, pages 1222-1224, a method for modulating the coupling coefficient along the waveguide is proposed. It is proposed a “nonperiodic” sampled grating having two sections, the grating region and the space region. The ratio between the lengths of the grating and space regions changes along the waveguide (for this reason the grating is defined in the article as being nonperiodic), resulting in a modulation of the coupling coefficient. Experiment with a sampled grating on a InGaAs/InP double-hetero structure having a period of 0.24 μm of consisting of 50 units, each having a length of 2.16 μm, is described.

Applicants have noted that the presence of a constant unit length subdividing the grating introduces the so-called “Moiré replica” on the filter spectrum. Moiré replica are peaks present in the filter reflection spectrum at wavelengths in the vicinity of the Bragg wavelength, said wavelengths being determined by the periodicity of the sampled grating. The presence of Moiré replica is particularly undesired when a wavelength-selective filter operating over a relatively large wavelength band, e.g., 20-30 nm, is to be produced.

U.S. Pat. No. 6,549,707 in the name of France Telecom, an optical device is presented in which an optical parameter varies along the path of the traveling wave in such a manner that the device has a series of sections each constituted by a pair of two successive segments, one in which the values of the optical parameter are less than an average value and the other in which the values of the optical parameter are greater than the average value. The device has at least one zone in which the sections have lengths alternatively less than and greater than an average length of the section in that zone. Applicant has noted that the realization of such an apodized grating is technologically demanding because it requires the realization of pitches having many different widths, one following the other. Since all the widths need to be defined with a high precision, control of the etching step may result difficult. Furthermore, the fabrication of pitches of very small width (e.g., 100 nm or less) can come at the cost of the accuracy in the definition of the grating.

### SUMMARY OF THE INVENTION

The present invention relates to an optical device which comprises an apodized Bragg grating. The optical device hereby considered is such that an optical signal comprising one or more wavelengths may travel through it and the device is capable of selecting the optical signal at a given wavelength. The selected wavelength is called the Bragg wavelength (λ_{B}) and it is defined by the Bragg relation

λ_{B}=2·n_{eff·Λ} (1)

where Λ is the grating period and n_{eff} is the effective refractive index of the mode propagating along the optical device.

Although in this context with the term waveguide also optical fibers are included, the invention is preferably applied in an optical device comprising a planar waveguide. Preferably, the grating is fabricated by suitable etching techniques, i.e., it forms an etched grating structure. For example, the grating may comprise a plurality of teeth having a given width w, each followed by a groove (i.e. the grating comprises a plurality of empty trenches formed by etching the waveguide material). Alternatively, the grating can comprise for example alternated regions made of materials of different refractive index, e.g., silicon nitride and silicon oxide in a silicon oxide waveguide. However, it is to be understood that the teaching of the invention applies as well to gratings obtained by irradiation (such as UV exposure). In any case, the grating provides an effective refractive index variation (due to the different refractive indices of the adjacent regions of the grating) along the path of the optical signal that travels in the optical device.

In the following, a uniform Bragg grating defines a grating in which the refractive index variation (or modulation) is periodic along the grating length. The reflection spectrum of a uniform Bragg grating of finite-length is accompanied by the presence of sidelobes at wavelengths close to the Bragg wavelength (typically a series of sidelobes around the reflection peak centered at the Bragg wavelength). The refractive index variation should not be constant along the grating in order to minimize or suppress the sidelobes. In other words, the coupling coefficient (or grating strength) should vary along the grating.

One of the main goals of the present invention is therefore to realize an optical device including a grating, which achieves a good sidelobe suppression.

A further goal of the present invention is to realize an optical device having a spectral response that does not exhibit Moiré replica. This is particularly advantageous in case the optical device is a wavelength-selective optical filter operating over a relatively wide wavelength range, e.g. the C-band (1530-1565 nm). According to a preferred embodiment of the present invention, the optical device is a tunable channel add/drop filter for wavelength-division-multiplexing (WDM), where the wavelengths can be tuned within a wavelength band, e.g., the C-band.

In addition, a preferred aim of the invention is to realize an optical device including an etched grating of relatively simple fabrication.

According to the present invention, modulation of the coupling efficiency of a grating of finite length L is achieved by dividing the grating length, L, into a plurality of sections, Sₙ (n=1, . . . , N), each section including two sub-sections: a first sub-section, S_{n,R}, having a first grating period Λ corresponding to the Bragg wavelength of interest, λ_{B}—i.e., the desired wavelength to be filtered (reflected) by the optical device according to relation (1)—and a second sub-section, S_{n,T}, having a second grating period Λ₁, corresponding to a wavelength—always according to relation (1)—that lies outside the wavelength range of interest during operation of the optical device. The first sub-section, S_{n,R}, will be referred to as the reflective subsection (the coupling coefficient of the grating is maximum or close to the maximum) and the second sub-section, S_{n,T}, will be referred to as the transmissive sub-section (i.e., in this sub-section the coupling coefficient is substantially zero). For instance, for an optical filter operating in the C-band, the grating period Λ₁ of the transmissive sub-section is such that the wavelength λ₁ defined by λ₁=2·n_{eff}·Λ₁ is such that λ₁≠λ_{B} and lies outside the wavelength range of about 1530-1565 nm.

In the preferred embodiments, each section Sₙ consists of two sub-sections, i.e., Sₙ=S_{n,R}+S_{n,T}. Although it is not excluded that the transmissive sub-section S_{n,T} comprises segments of different grating periods (e.g. Λ₁, Λ₂, etc.) corresponding to non-reflective wavelengths (λ₁, λ₂, etc.), it is however preferable that a single grating period Λ₁ is selected in order to simplify the realization of the grating.

Each section Sₙ has a given length Iₙ (n=1, 2, 3 . . . , N). Preferably, each section length Iₙ is much smaller than the grating length L. Preferably, N is not smaller than 20, more preferably not smaller than 50. The preferred value of N depends also on the length, L, of the grating and on its refractive index contrast.

Each section length Iₙ is given by Iₙ=I_{n,R}+I_{n,T}, where I_{n,R} is the length of the reflective sub-section and I_{n,T} is the length of the transmissive sub-section.

Therefore, the grating of the invention is non uniform and can be thought as a grating of period Λ wherein, in the sub-sections in which the refractive index variation having period Λ is not present, another variation of period Λ₁≠Λ is realized. The grating strength of each of the N sections, Sₙ, is represented by the ratio I_{n,R}/(I_{n,R}+I_{n,T}) and modulation of the grating strength over the different sections is achieved by varying said ratio.

According to the present invention, the length of each section, is selected in such a way that the sequence of section lengths, V=[I₁,I₂, . . . ,I_{N}], does not exhibit any periodicity. Typically, but not necessarily, two adjacent sections, e.g., Iₙ and Iₙ₊₁, do not have the same length. Preferably, the sequence of lengths, V, is chosen according to a random function. By selecting a non-periodic sequence V of section lengths, Moiré replica, which are typically present in sampled gratings, are avoided and the spectral response of the optical device does not exhibit significant peaks additional to that centered at the Bragg wavelength.

Preferably, Λ₁>Λ for the Bragg wavelengths of common interest in optical filters for WDM so as to simplify the realization of the grating, especially if made by etching, because the realization of a smaller Λ₁ may be technologically demanding.

Preferably, to maintain the propagating optical field in phase at the entry of each. reflective sub-section S_{n,R}, the first and second grating periods are selected so as to satisfy the following equation: nΛ=mΛ₁, where n, m are integers. If Λ₁>Λ, the ratio n/m is not an integer because an integer n/m, e.g., Λ₁=2Λ, would make the filter to be reflective also in the sub-sections with period Λ₁. On the other hand, if Λ₁<Λ, m/n is selected to be a non-integer for the same reason.

In order to obtain a symmetrical reflection spectrum, the duty cycle of the refractive index modulation having period Λ is preferably equal to the duty cycle of the refractive index modulation having period Λ₁ and it is constant in each grating section, Sₙ. In this way, the duty cycle is constant along the whole grating length L. A constant duty cycle implies a constant local mean value of the effective refractive index.

Preferably, the duty cycle of the grating is 50% in order to obtain the maximum grating reflectivity. However other duty cycles may be employed as well.

### BRIEF DESCRIPTION OF THE DRAWINGS

Further features and advantages of an optical device including an apodized grating and of a method to realize an apodized grating according to the present invention will become more clearly apparent from the following detailed description thereof, given with reference to the accompanying drawings, where:

FIG. 1 is a schematic lateral view of a portion of the optical device according to an embodiment of the invention;

FIG. 2 is a graph relative to simulations of spectral response of a Bragg grating apodized according to an ideal continuous apodization function (e.g., waveguide index variation through UV exposure);

FIG. 3 is graph relative to simulations of spectral response of a Bragg grating apodized according to the method of the invention;

FIG. 4 is a graph relative to simulations of spectral response of a Bragg grating apodized according to the method of the invention in a different wavelength region compared to FIG. 2.

### PREFERRED EMBODIMENTS OF THE INVENTION

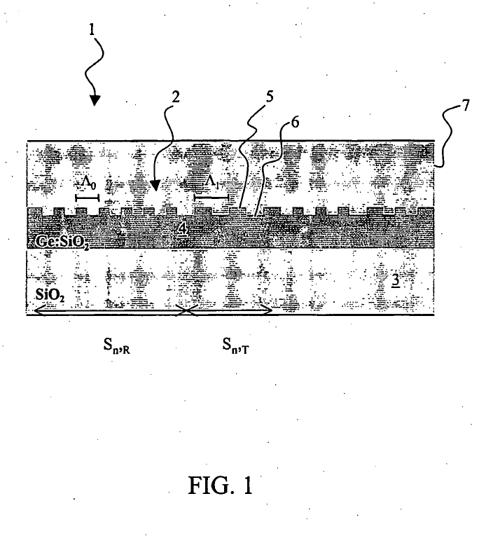

With reference to FIG. 1, an optical device realized according to an embodiment of the present invention is indicated with 1.

The optical device 1 includes a grating 2, in particular an apodized grating, having a total length equal to L. According to a preferred embodiment of the invention, optical device 1 is a planar waveguide including a core 4 and a cladding 3. Grating 2 can be realized either on its core 4 or on its cladding 3 (or in both core and cladding) by forming a modulation of the effective refractive index n_{eff} of the waveguide. In FIG. 1, the grating 2 is illustrated on the core 4 of the planar waveguide. According to a preferred embodiment, the modulation of n_{eff} is realized by etching, and thus the grating is formed by a plurality of teeth 5 and adjacent grooves 6 (which may be also filled by a different material). In the example of FIG. 1, grating 2 is formed by etching and the grooves 6 are filled by the material of the cladding 3, more precisely by the material of the upper cladding 7.

A planar waveguide including an apodized grating according to the invention, for instance of the type illustrated in FIG. 1, could be used as wavelength-selective filter for example in a WDM system comprising a plurality of sources emitting light at different wavelengths.

The main spectral features of the grating 2, both for a photorefractive grating and for an etched grating, can be fully derived once the modulation of the effective refractive index n_{eff} is known. Different known methods can be applied in order to simulate the spectral response, such as the Coupled Mode Theory or Tranfer Matrix Method.

The effective refractive index modulation along the propagation axis z can be expressed in general as:

$${n}_{eff} ( z ) = {n}_{0 , eff} ( z ) + Δ {n}_{eff} \cdot g ( z ) \cdot cos ( \frac{2 π}{Λ ( z )} z + φ ( z ) ) \qquad ( 2 )$$

where n_{0.eff}(z) is the effective refractive index local mean value of the propagating mode, Δn_{eff} is the maximum effective index perturbation, g(z) is the normalized envelope of the effective refractive index modulation (the apodized function), Λ(z) is the local period of the varying refractive index modulation, and φ(z) is a correction factor that takes possible phase shifts along the grating into account.

The assumption of sinusoidal modulation of Eq. (2) is not restrictive. In fact, it is always possible to expand effective refractive index in a Fourier series and consider one component at a time.

The refractive index local mean value n_{0.eff}(z) is calculated by averaging n_{eff}(z) over a convenient length, longer than several periods but shorter than the overall grating length.

The grating 2 reflects selectively wavelengths that satisfy the Bragg condition:

$${λ}_{B , M} = \frac{2 \cdot Λ \cdot {n}_{eff}}{M} \qquad ( 3 )$$

where M is an integer that indicates the grating order. In the preferred embodiments, only first order gratings are considered (M=1), since contributions from higher order gratings are at wavelengths outside the region of interest, e.g., outside the C-band. Therefore, the optical device of the invention is so realized that it reflects a selected wavelength, λ_{B}, according to relation (1).

The grating 2 is apodized, in order to achieve sidelobe suppression in the spectral response of the device 1. This means that the envelope g(z) of the effective refractive index modulation is not constant, as it happens for uniform gratings, but it follows a sufficiently slow function of the position z along the grating itself. In the following, uniform Bragg gratings will be said to have a “constant index modulation”, i.e. g(z) is constant.

In the grating of the invention, preferably the effective refractive index local mean value of the propagating mode n_{0.eff}(z) is kept constant in order to obtain a symmetric spectral response with high sidelobe suppression. If n_{0.eff}(z) is not constant different situations could arise. For example, if n_{0.eff}(z) has a linear trend, different portions of grating reflect different wavelengths. Thus, the bandwidth tends to increase while maximum reflectivity tends to decrease. This condition is equivalent to imposing a linear chirp to the grating. Moreover, if n_{0.eff}(z) has a second derivative different from zero, adjoining portions of grating reflect different wavelengths, while non-adjoining sections reflect the same wavelength, which is different from the desired central wavelength. This situation gives rise to Fabry-Perot cavities. If the second derivative is negative, then the cavity resonates at lower wavelength than the desired wavelength. The opposite happens if the second derivative is positive.

In the literature, different apodization functions—indicated in expression (2) with g(z)—are reported, each of them describing a different refractive index envelope trend. Apodization functions such as Hamming, Raised Cosine, Blackman or Hyperbolic Tangent are quite common in the field.

In order to physically implement apodization, different approaches could be followed depending on the grating type.

For photorefractive gratings, a straightforward approach consists in the modulation of the UV radiation intensity according to the same function that is of interest for the refractive index variation. This is possible since, as a first approximation, a linear relationship holds between the UV radiation intensity and the refractive index increase obtained in the photorefractive waveguide. Constant value for the index local mean value n_{0.eff}(z) can be easily achieved. Possible techniques belonging to this family are apodized phase mask, double exposure with a Phase Mask, and phase mask dithering.

When physically etched gratings are considered, the modulation of the grating strength can be obtained either by modulating the corrugation duty-cycle along the grating or by controlling the depth of each groove or trench. Anyway, in both these cases, it is not possible to keep constant the index local mean value n_{0.eff}(z).

In case of physically etched gratings, the “duty cycle” can be defined as the ratio of the grating-tooth width w and the grating period Λ (or Λ₁). With reference to FIG. 1, the grating tooth is indicated with reference number 5, whereas the “groove” adjacent to the tooth is indicated with 6. For duty cycles smaller than 50%, the grating tooth is narrower than the adjacent grating groove. Conversely, for duty cycles bigger than 50%, the grating tooth is wider than the grating groove (an analogous definition can be made in case of grating formed by irradiation).

The duty cycle of the corrugations in the reflective sections and in the transmissive sections is kept constant in order to keep constant the index local mean value n_{0.eff}(z). In the present invention the grating length L is subdivided in N sections Sₙ, having lengths Iₙ (n=1, 2, . . . , N). The section length, Iₙ, is preferably much smaller than the grating length L. Preferably, N is not smaller than 20, more preferably not smaller than 50. A relatively high N (e.g., N not smaller than about 100) tends to decrease discretization problems.

The grating is divided in a series of contiguous sections Sₙ, which comprise sub-sections that are either transmissive (the sub-sections comprise a corrugation having period Λ₁) or reflective (the sub-sections comprising a corrugation having period Λ) for the wavelength of interest according to Eq. (1). To a transmissive sub-section, a reflective sub-section follows and vice versa. In the preferred embodiments, each section Sₙ of length Iₙ, is divided in two sub-sections, a first sub-section of period Λ, i.e., the reflective sub-section, S_{n,R} of length I_{n,R}, and a second sub-section of period Λ₁, i.e., the transmissive sub-section, S_{n,T} of length I_{n,T}. The grating strength of each of the N sections, Sₙ, is represented by the ratio I_{n,R}/(I_{n,R}+I_{n,T}). Modulation of the grating strength over the different sections is achieved by varying said ratio. The ratio can be selected within the range between zero (the section has no reflective sub-section) and one (the section has no transmissive sub-section). Typically, each section can include a dozen of grating periods, the number of grating periods depending also on the section length, Iₙ.

Preferably, the first and second period are so selected that nΛ=mΛ₁, where n, m are integers. This condition permits phase matching between subsequent reflective sub-sections. If Λ₁>Λ, n/m is not an integer, whereas if Λ₁<Λ, m/n is a non integer. According to the present invention, the succession of lengths of each section Sₙ, V=[I₁, I₂, . . . I_{N}], is non periodic in order to avoid the presence of Moiré replica in the operating wavelength region of the optical device.

Preferably, the length Iₙ of each section Sₙ is randomly chosen. In particular, a random number generator may generate a plurality of lengths which are then scaled in order to obtain N values which are multiples of the first period Λ. Alternatively, the random number generator can generate random numbers which are already multiples of the first period Λ. Each of these randomly selected values of lengths is associated to a section Sₙ of the grating 2. An example of such a random number generator is the function RAND of Matlab®. However any other standard random function may be used.

Preferably, the section located at the center of the grating consists of a reflective sub-section, Sₙ=S_{n,R} (S_{n,T}=0) with corrugation of period Λ.

In the following a more mathematical description of the invention is given.

Let be g(z) the apodization target function, which can be arbitrary chosen among any known apodization function (for example, a Raised Cosine or an Hyperbolic Tangent function), ĝ(z) is a binary function (i.e., taking the value of 1 or of 0) that mimics the effect of g(z) in a discrete way according to the present teachings. When ĝ(z) is equal to 1, a first corrugation with a first period Λ is present in the grating 2 (i.e., ĝ(z)=1 in the reflective sub-sections); on the contrary, when ĝ(z) is equal to 0, a corrugation with a different second period called Λ₁ is present in the grating 2 (ĝ(z)=0 in the transmissive sub-sections). The first period Λ is so selected that the corresponding Bragg wavelength, λ_{B}, is the wavelength of interest to be filtered by the optical device 1.

The effective refractive index n_{eff} thus can be expressed as:

$${n}_{eff} ( z ) = {\overline{n}}_{0 , eff} + Δ {n}_{eff} \cdot \cdot \{ \overline{g} ( z ) \cdot f ( \frac{2 π}{Λ} z ) + [ 1 - \hat{g} ( z ) ] \cdot {f}^{′} ( \frac{2 π}{{Λ}_{1}} z + {ϕ}_{n} ) \} \qquad ( 4 )$$

where f and f′ are periodical functions and φₙ is a phase correction for each section. If Λ and Λ₁ are properly selected (according to the relation nΛ=mΛ₁ previously discussed), the phase correction is not necessary as the propagating optical mode enters each reflective sub-section in phase and therefore a phase correction factor, φ(z), does not need to be introduced.

Equivalence between target apodization function and the binary apodization function is expressed by:

$${\int }_{{l}_{n}}^{ } {g}^{⋒} ( z ) \cdot d z = {\int }_{{l}_{n}} g ( z ) \cdot d z . \qquad ( 5 )$$

Namely, the local mean value of ĝ(z), i.e., within the section length, Iₙ, is equal to that of g(z) or in other words, the function ĝ(z) mimics in a discrete way the function g(z). Preferably, the index local mean value n_{0,eff}(z) is kept constant, which is expressed by the condition:

$${\int }_{{z}_{0}}^{{z}_{0} + r Λ} f ( z ) \cdot d z = {\int }_{{z}_{1}}^{{z}_{1} + r {Λ}_{1}} {f}^{′} ( z ) \cdot d z = 0 \qquad ( 6 )$$

for each z₀, z₁ along the grating length L, where r is an integer number on the order of some units.

In order to avoid the presence of Moiré replica, the sequence of section lengths, V=[I₁, I₂, . . . I_{N}], is non periodic. The non-periodicity of the section length sequence can be defined by considering the Fourier series of the binary function ĝ(z):

$$F ( \hat{g} ( z ) ) = {\sum }_{j} {c}_{j} {e}^{- i {k}_{j} z} \qquad ( 7 )$$

where cⱼ are the Fourier coefficients and kⱼ=2π/Λⱼ, with Λⱼ the j-grating period. At the Bragg wavelength, kₒ=2π/Λ, whereas at the grating period Λ₁, k₁=2π/Λ₁. The respective Fourier coefficients corresponding to kₒ and k₁ are c₀ and c₁, respectively. Since the apodized grating has two periods (Λ and Λ₁), normally, the values of c₀ and c₁ are of the same order. A non-periodic section length sequence means that the Fourier coefficients cⱼ different from c₀ and c₁ are much smaller than c₀ and c₁, i.e., at least of a factor of about 100. In other words, the only significant terms of the Fourier series of Eq. (7) are those corresponding to the grating periods Λ and Λ₁. It is to be noted that a relatively large value of c₁ (typically of the same order as c₀) does not cause Moiré replica in the wavelength region of interest because the grating period Λ₁ is selected such that the wavelength λ₁ defined by λ₁=2·n_{eff}·Λ₁ lies outside such wavelength region.

According to a preferred embodiment of the method of the invention, the target apodization function g(z) is preferably a Super-Gaussian function. In fact, most symmetric functions used in the prior art as apodization functions can be cast in the general form of a normalized Super-Gaussian function g(z) whose parameters are the variance a and the exponent q:

$$g ( z ) = \frac{exp ( - {u}^{q} ) - exp ( - {u}_{0}^{q} )}{1 - exp ( - {u}_{0}^{q} )} \qquad ( 8 )$$

where:

$$u = \vert \frac{z}{σ \cdot {L}_{g}} \vert$$

$${u}_{0} = \vert \frac{{L}_{g} / 2}{σ \cdot {L}_{g}} \vert$$

and L is the grating length and z ∈[−L/2, L/2] describes the actual position along the grating axial axis. At the center of the grating, z=0, g(z), and hence the grating reflectivity, is at its maximum.

The advantage of this formulation is the possibility to maximize spectral response characteristics over a continuum of apodization functions. The binary function ĝ(z) is defined so that Eq. (5) is satisfied. This implies that the binary function ĝ(z) should generate basically the same spectral response as that of the Super-Gaussian function g(z) of Eq. (8) in terms of extinction ratio, bandwidth and sidelobe suppression.

### EXAMPLE 1

The grating 2 of the invention may be realized as a physical corrugation on a waveguide with refractive index contrast equal to 0.7%. The waveguide has an undoped SiO₂ cladding 3 and a Ge-doped SiO₂ core 4. Possible dimensions for the core 4 are 4.5×4.5 m².

The physical corrugation for such a grating is supposed to be on top of the core. The fundamental period Λ of the grating depends on the desired Bragg frequency of resonance and on the effective refractive index according to (1). For application in the third optical window (1550 nm) Λ is on the order of 500 nm. The depth of such corrugation depends on the desired effective index contrast Δn_{eff}. As an example, it is on the order of hundreds of nanometers.

In FIG. 1 a lateral view of the core 4 supporting the grating 2 is reported. A reflective sub-section, S_{n,R}, at the fundamental period Λ followed by a transmissive sub-section, S_{n,T}, with second period Λ₁ (in this case 1.5 times the fundamental, thus n/m=1.5) is illustrated in FIG. 1.

### EXAMPLE 2

In the present example, the grating 2 is designed to be suitable for application in WDM systems as a filter on a 100 GHz ITU grid. The grating is formed on a waveguide comprising a core made of Ge-doped SiO₂ and a cladding surrounding the core made of undoped SiO₂.

The grating is formed on the waveguide cladding in SiO₂ and comprises a plurality of teeth with n₁=1.45 followed by empty grooves with n₂=1. The following grating 2 characteristics could satisfy general requirements for such type of a grating:
Grating length L=9 mm;
Depth of the grating trenches: 500 nm;
Grating period Λ: 532 nm;
Second period Λ₁: 798 nm, Λ₁=1.5 Λ;
distance of the grating from the core d=500nm.

Parameters of the Super-Gaussian apodization function:
σ=0.3;
q=2.3;
Λn_{eff}=8·10⁻⁴;
Bragg frequency=194 THz.

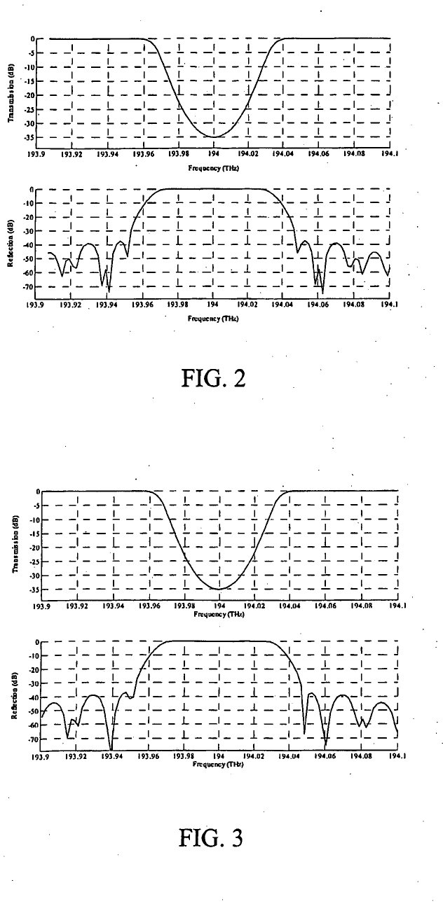

In FIG. 2 the simulation of spectral response (transmission and reflection) is reported for such a grating. The simulation is performed through a standard Transfer Matrix approach. The spectral response is obtained by using the continuous Super-Gaussian function g(z) of Eq. (2) using the above identified parameters.

The apodization of the present invention has been applied to obtain the same grating characteristics as above indicated. A proper ĝ(z) is created to simulate the behavior of the selected Super-Gaussian function. FIG. 3 reports the simulation of spectral response (transmission and reflection) for this case.

From the comparison of FIGS. 2 and 3 (upper figures), it can be said that both apodization approaches can satisfy requirements of maximum extinction of the transmission spectrum, i.e., the depth of the reflected peak in the transmission response (−35 dB in the examples reported in FIGS. 2 and 3), bandwidth, and sidelobe suppression. Quantitative evaluations give for these parameters substantially the same results.

The intensity of sidelobes in both cases in less than about 40 dB, thus making the filter suitable for instance for dense WDM (DWDM) systems.

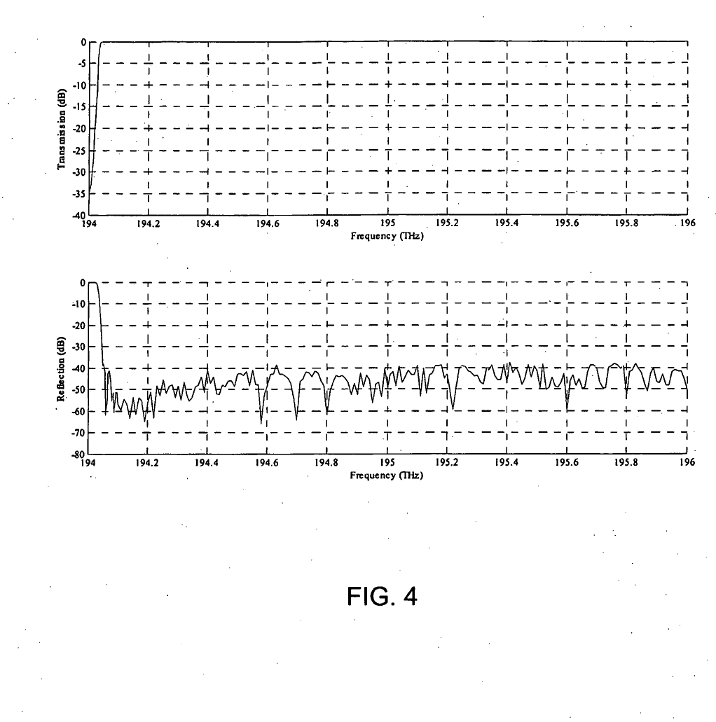

Considering now FIG. 4, it is possible to verify the absence of Moiré replica in a wavelength window of 4 THz, corresponding to about 32 nm (only the side right to the Bragg wavelength of the reflection spectrum in shown as the spectrum is symmetric), i.e., substantially the bandwidth of the C-band.

The optical device of the invention may be used as part of an optical filter or in an add and drop multiplexer. The optical device of the invention can filter out a single channel at the Bragg wavelength from an optical beam including a plurality of channels to be directed for example to an optical receiver, or another signal of wavelength λ_{B} can be added to the optical signal outputted from the device of the invention.

1-14. (canceled)

15. An optical device comprising an apodized grating having a finite length and being capable of filtering a first wavelength within an operating wavelength region,
said grating comprising a plurality of consecutive sections, each section having a length and comprising two sub-sections: a first sub-section having a first period Λ and a second sub-section having a second period Λ₁, wherein
said first period (Λ) satisfies the Bragg condition for said first wavelength and said second period Λ₁ satisfies the Bragg condition for a second wavelength lying outside said operating wavelength region, and
succession of lengths of the sections is non periodic.

16. The optical device of claim 15, wherein the first period (Λ) and the second period (Λ₁) are such that nΛ=mΛ₁, where n and m are integers and satisfy one of the following conditions:
if Λ₁>Λ, n/m is not an integer; and
if Λ₁<Λ, m/n is not an integer.

17. The optical device according to claim 15, wherein said second period (Λ₁) is longer than said first period (Λ).

18. The optical device according to claim 17, wherein Λ₁=1.5 Λ.

19. The optical device according to claim 15, wherein the length of said sections is randomly selected.

20. The optical device according to claim 15, wherein the duty cycle of the constant refractive index modulation having said first period (Λ) is equal to the duty cycle of the constant refractive index modulation having said second period (Λ₁).

21. The optical device according to claim 20, wherein said duty cycle is equal to 50%.

22. The optical device according to claim 15, wherein the distribution of said sections in said grating is such that the corresponding normalized envelope of the refractive index modulation is a discrete approximation of a continuous apodization function.

23. The optical device according to claim 22, wherein the continuous apodization function is a Super-Gaussian function.

24. The optical device according to claim 15, wherein the optical device is a wavelength-selective optical filter and the operating wavelength region is the C-band.

25. A method of realizing a grating apodization in an optical device by modulating the refractive index in order to obtain an apodized grating of length (L) capable of filtering a first wavelength within an operating wavelength region of said optical device, comprising the steps of:
selecting a first period (Λ) and a second period (Λ₁), said first period satisfying the Bragg condition for said first wavelength and said second period (Λ₁) satisfying the Bragg condition for a second wavelength lying outside said operating wavelength region, thereby forming a grating with modulated coupling coefficient;
selecting a continuous apodization function corresponding to the normalized envelope of the effective refractive index modulation;
partitioning the grating length (L) into a plurality of consecutive sections, each section having a length In, where I₁+I₂+. . . +I_{N}=L, and each section comprises two sub-sections: a first sub-section having said first period Λ and a second sub-section having said second period Λ₁; and
selecting the length of each section (Iₙ; n=1, 2, . . . ,N) such that the sequence of lengths [I₁, I₂, . . . I_{N}] is non periodic.

26. The method of claim 25, wherein the first period (Λ) and the second period (Λ₁) are such that nΛ=mΛ₁ where n and m are integers and satisfy one of the following conditions:
if Λ₁>Λ, n/m is not an integer; and
if Λ₁<Λ, m/n is not an integer.

27. The method according to claim 25, wherein the distribution of the sections is such that the corresponding normalized envelope of the refractive index modulation in the grating is a discrete approximation of said continuous apodization function.

28. The method according to claim 27, wherein said first sub-section has a length I_{n,R} and said second sub-section has a length I_{n,T} and wherein the distribution of sections is obtained by varying the ratio I_{n,R}/(I_{n,R}+I_{n,T}).
